(19) United States
(12) Patent Application Publication
(10) Pub. No.: US 2018/0012506 A1
(43) Pub. Date: Jan. 11, 2018

(54) SYSTEM AND METHOD FOR TRAINING COGNITIVE SKILLS UTILIZING DATA ADDITION TO VIDEOS

(71) Applicant: Kadho Inc., Irvine, CA (US)

(72) Inventors: Kaveh Azartash, ALISO VIEJO, CA (US); Dhonam Pemba, Toluca Lake, CA (US); Yasuto Suga, Huntington Beach, CA (US)

(21) Appl. No.: 15/202,703

(22) Filed: Jul. 6, 2016

(51) Int. Cl. G09B 7/077; G09B 5/12; A63F 13/25; G11B 27/029; G09B 19/00

(52) U.S. Cl. CPC G09B 7/077; G11B 27/029; G09B 19/0038; A63F 13/25; G09B 5/125; G09B 19/00

(57) ABSTRACT

A cognitive skill development method and system for training users in various fields wherein data is added to a video and the video is played on a user device in accordance with such data. Video interruption techniques such as video occlusion are used to interrupt the video. The user is then presented with questions corresponding to the video and the user's response to such questions is solicited and recorded.

### BACKGROUND

The world today attaches a great deal of importance on an individual's cognitive abilities. Most high skill based activities such as sports, military activities, firefighting etc. require improved cognitive abilities and hence there is a constant need of keeping these honed. Every now and then, new methods are introduced so as to improve a person's cognitive skills. However, most of these methods involve the age old techniques of physical and mental exercises, on field training, increasing attention to detail etc., which prove to be only a partial success. This is mainly due to the fact that these techniques try to enhance the overall cognitive abilities rather than focusing on specific abilities. Individual attention to each cognitive function would play a great role in developing specific cognitive skills in individuals.

The need for highly specific cognitive skill development activities has been rightly identified and efforts are made to fill this vacuum. Among the activities employed now, one of the most popular ones is the interactive video occlusion training wherein the user is required to give quick responses to real life cognitive skill building scenarios. Another preferred mode of cognitive skill development is through video games. These video games stimulate various scenarios in which the cognitive abilities of the player are tested and put to use. In these games, an interruption is caused at which point the player will be required to enter an appropriate response based on the scenarios created by the game. The player's response is analyzed and compared to the most ideal outcome. However, this too is present in a limited and rudimentary form. The video game occlusion training methods currently available suffer from two major setbacks; firstly, it is a stimulated scenario and hence may not be able to take into effect all of the real world stimuli and other external factors that may have an impact on the real life outcome of such a scenario and secondly, most of these video games are limited in their interactive capabilities i.e., there are only a limited set of responses that the user may enter and the mode of response is mostly through additional hardware such as controllers, keyboards, mouse and other input devices. Most of the times either the occlusion is not at the right frame of the video or once the video is occluded the user finds it difficult to answer questions with respect to multiple frames that passed before the occlusion. Hence, these games are unable to track the performance of the player/user appropriately and cannot provide accurate feedback as to the development of the player's cognitive abilities.

There is a great need of a highly interactive system wherein the player is required to continuously respond to highly specific questions with regard to the right occlusion point. Continuous interaction by the player would better enable the player in enhancing his or her cognitive skills as the scenarios are created and responses are to be entered at the point of occlusion. The video games should ensure that the questions are highly specific and that the player is continuously engaged. The player's response should ideally be obtained at the point of occlusion so that the player is able to recollect and respond in a much more accurate manner. The game must also evaluate the performance of the player based on the various responses and an accurate analysis of the development of the cognitive skill should be provided to the player. Furthermore, these games should ensure that the scenarios are neither repetitive nor predictable and that the player is continuously challenged.

### SUMMARY OF THE INVENTION

The method provided herein relates to a method for specific cognitive skill development of a user. The method comprises adding data to a video, the combination of data and the video thereby resulting in a data added video. Presenting the data added video to a user on a user device. Once the user plays the data added video, interrupting the data added video at a predetermined time in accordance with the data added to the video. Once the video is interrupted, presenting the user with at least one question in relation to the data added video and soliciting user's response to the question. The method may further comprise of analyzing the user's response by comparing the response with the actual outcome. After the user records his/her response, the data added video may continue playing to show the actual outcome to the user.

The method may further comprise automatically increasing or decreasing the difficulty level of the interruption or the question asked to the user based on the accuracy of user responses. In one embodiment, a video tool is used to export data for addition of such data to a video. The user device is configured to run a video output module that is configured to import the data and the video and play the data added video in accordance with the data. A remote server or a cloud server may be used to store the data and the video wherein the user device may be permitted to download/import the data and the video.

In one embodiment, the system architecture capable of utilizing the method provided herein comprises a first computing device configured to export data for addition of the data to a video resulting in a data added video. A user device is configured to play the data added video in accordance with the data. A processor associated with the user device is configured to interrupt the data added video in accordance with the data and the processor further configured to present at least one question in relation to the data added video to the user. An input means is configured to receive the user's response to said question.

The method and system provided herein is capable of utilizing a real life video, simulated video or an animated video and may be used in any domain including but not limited to sports, firefighting, military training, driving and pilot training etc.

Furthermore, a system is provided for developing specific cognitive ability of a user, in some embodiments, the system comprising: a first computing device configured to export data for addition of said data to a video resulting in a data added video;

a user device configured to play said data added video in accordance with said data; a processor associated with said user device configured to interrupt said data added video in accordance with said data and said processor further configured to present at least one question in relation to said data added video to said user; and an input means configured to receive said user's response to said question.

Additionally, when referring to the system above, in some embodiments, said user device is a computing or mobile device

Additionally, when referring to the system above, in some embodiments, said user device is a video game console.

Additionally, when referring to the system above, in some embodiments, the system further comprises a server configured to store said data and said video wherein said first computing device is capable of exporting data to said server and said user device is capable of downloading said data and said video from said server.

Additionally, when referring to the system above, in some embodiments, said first computing device is configured to run a video tool capable of exporting said data in a predetermined format for use of said data by said user device.

Additionally, when referring to the system above, in some embodiments, said user device is configured to run a video output module capable of importing said data and said video and play said data added video in accordance with said data.

Additionally, when referring to the system above, in some embodiments, said interruption is in the form of video occlusion.

Additionally, when referring to the system above, in some embodiments, said video occlusion of said data added video is achieved by replacing the occluded video by a freeze frame.

Additionally, when referring to the system above, in some embodiments, said video is a real life video.

Additionally, when referring to the system above, in some embodiments, said video is a simulated video.

Additionally, when referring to the system above, in some embodiments, said video is an animated video.

### BRIEF DESCRIPTION OF THE DRAWINGS

FIG. 1 illustrates a flow diagram of presenting data added video to the user in accordance with one embodiment of the invention

FIG. 2 illustrates a flow diagram of utilizing a video tool of exporting data to a video output module and presenting such video to a user

FIG. 3 is a series of snapshots illustrating a flow of the video game in accordance with one embodiment of the invention.

FIG. 4 FIG. 4 is an illustrative explanation of the manner and types of data that may be added to a video in accordance with one embodiment of the invention.

FIG. 5 is an illustrative screen shot of an alternate embodiment of occluding a video to seek user response.

FIG. 6a is an illustrative snapshot of an alternate embodiment of occluding a video to seek user response.

FIG. 6b is an illustrative snapshot of an alternate embodiment of occluding a video to seek user response.

FIG. 6c is an illustrative snapshot of an alternate embodiment of occluding a video to seek user response.

FIG. 7 is an illustrative embodiment of the system architecture that utilizes the cognitive skill development method described herein.

### DETAILED DESCRIPTION

The embodiments herein and the various features and advantageous details thereof are explained with reference to the non-limiting embodiments that are illustrated in the accompanying drawings and/or detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the scope of this patent application and the claims contained herein should not be construed as limited to the illustrative embodiments.

The cognitive skill development method for enhancing specific cognitive skills of users as provided herein comprises adding interactive and other data to a video and presenting such data added video to a user on a user device which may be a smart phone, tablet, laptop, video game console or any such device with display and processing capabilities. The video presented to the user is interrupted based on the data added and appropriate response is sought to such questions from the user. Though the video may be interrupted in many different ways, video occlusion is used as an illustrative scenario throughout this document. Additional features such as data analysis, performance analysis etc. may also be provided.

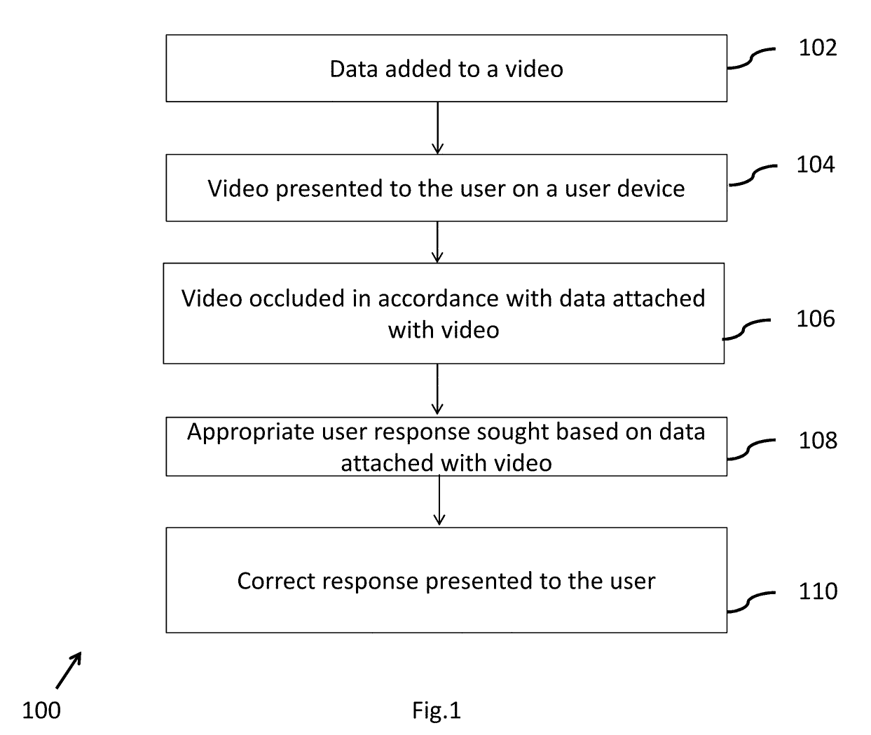

FIG. 1 is flow diagram 100 of an illustrative embodiment in accordance with the method provided herein. A video is selected and data is added to such video 102. This data may be of various types including but not limited to data governing the exact time after which the video is occluded, quiz that may be asked to a user at the point of occlusion, data related to increasing or decreasing the difficulty level of occlusion, data related to highlighting specific players, specific parts of the video etc. The data may be added to the video using data embedding or data addition techniques now known or developed in the future. The video with the data added to it (referred to as “data added video” throughout this document) is presented to a user on the user's device 104. Once the user plays the video, the video is occluded at a predetermined point 106 in accordance with the occlusion time provided in the data added to the video. At the occlusion point, a response is sought from the user 108 with respect to specific questions related to the occlusion point. Once the user enters such response via any input means, including but not limited to keyboard, mouse, touch capacitive display or gestures through augmented reality systems, the video continues playing to display correct response to the user 110.

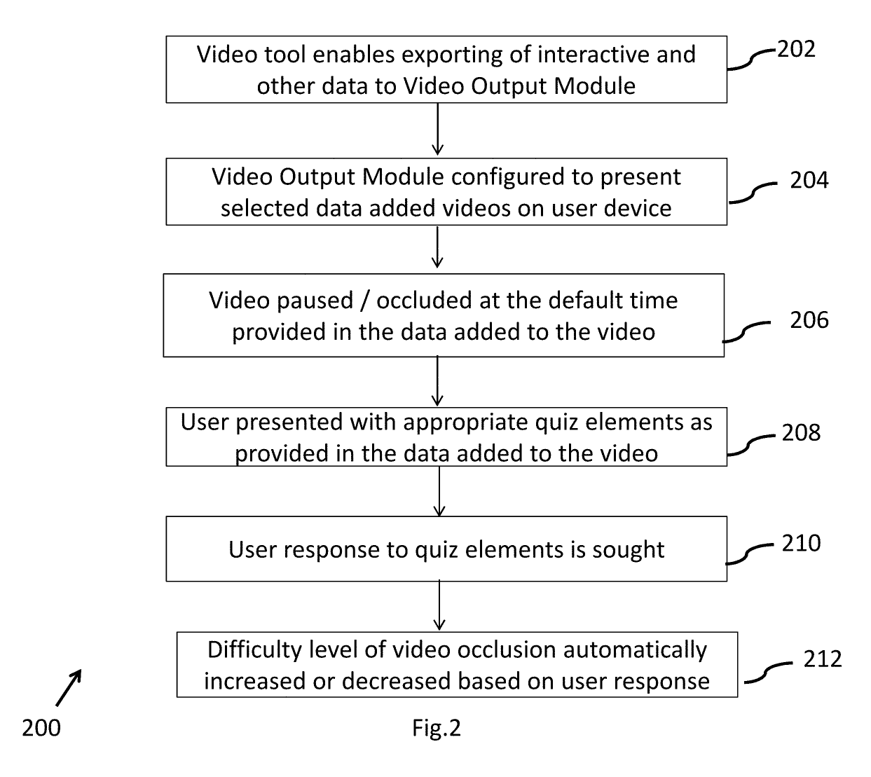

FIG. 2 is a flow diagram 200 of a preferred embodiment of the method provided herein. A video tool is used to export interactive and other data to a video output module 202. The video tool may comprise any known data embedding or data adding technique, now known or available in the future, used to add data to videos. The video output module is configured to present the data added videos on a user device 204, extract the data commands added to the video and accordingly add interactive elements to the video such as interruptions/occlusion, asking quiz, highlighting specific portions of the video, seeking user response etc. The video output module may either pick data added videos pre-stored in user device's storage or alternatively pick such data added videos from a remote or cloud server. The video output module occludes the video at a preset default time as per the data added to the video 206. Once the video is occluded, the user is presented with appropriate quiz elements in accordance with the data added to the video 208. The user response to the quiz elements is sought 210. Optionally, the data added to the video may automatically increase or decrease the difficulty level of the occlusion and the quiz based on user response 212.

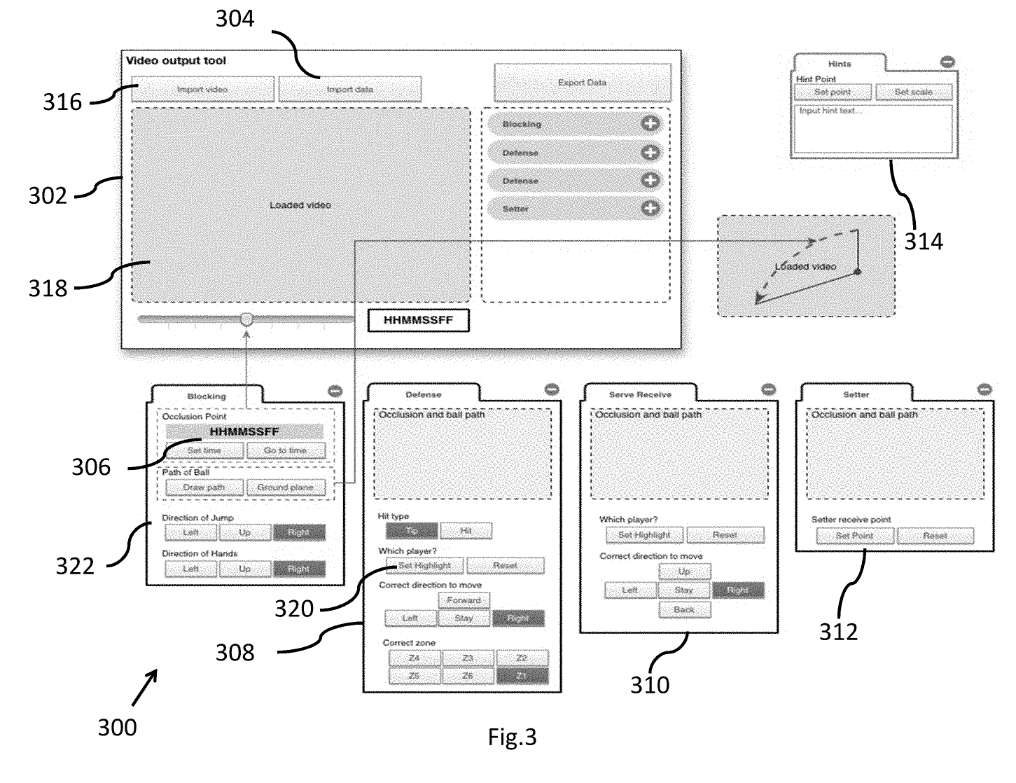

FIG. 3 is an illustrative embodiment 300 of the video output module 302 that is configured to import data from the video tool and play the video on the user device in accordance with such data. The video output module 302 has a data import option 304 that is used to add data to a give video that is imported within the video output module 302 using the video import tool 316. The video imported may be a real life video, simulated video or an animated video. Once the data is added to the video, the video is played using the video player 318 of the module 302. The data added to the video may include interactive data, occlusion related data and quiz related data modules among others. The occlusion related data may include a time code 306 preferably in the format HHMNISSFF that specifies the exact time (hour, minute and second) at which the video (exact frame) is to be occluded. The occlusion data may further provide the video output module 302 with the capability of automatically increasing or decreasing the difficulty level of the occlusion based on the accuracy of user's response.

The interactive data may be used to ask specific questions related to the scenario presented in the video. For example, for volleyball videos the interactive data modules may include blocking 322, defense 308, serve receive 310, setter 312 and ball path modules. The blocking module 322 focuses on the blockers upfront and may require the user to find the direction the blockers should jump to block the incoming ball. The user may respond by determining the direction of jump (left, up or right). The defense module 308 focuses on the players behind the blockers and may require the user to point out which direction (which zone) a specific player should go for correct defensive position i.e. to defend a current hit or tip. The serve reception 310 module helps players receive serve and aiding in defensive position when receiving a service. A specific player is highlighted and the user is asked about the direction that the highlighted player should go to for the correct defensive position. The setter module 312 requires the user to tap where the setter needs to be to receive an incoming pass. The interactive data module may also require the user to track the movements of a specific player by highlighting the player using the set highlight data element 320 or the player may be told to track the movement of the ball by allowing the user to draw the path of the ball. The video output module 302 may also provide hints 314 to users when the user's find it difficult to respond correctly. The user may respond to the questions raised in the interactive data module using various input mechanisms such as keyboard, mouse, interactive touch display of the user device, gestures through an augmented reality system etc. The quiz related data module may contain additional questions that the user may be asked with respect to a specific scenario.

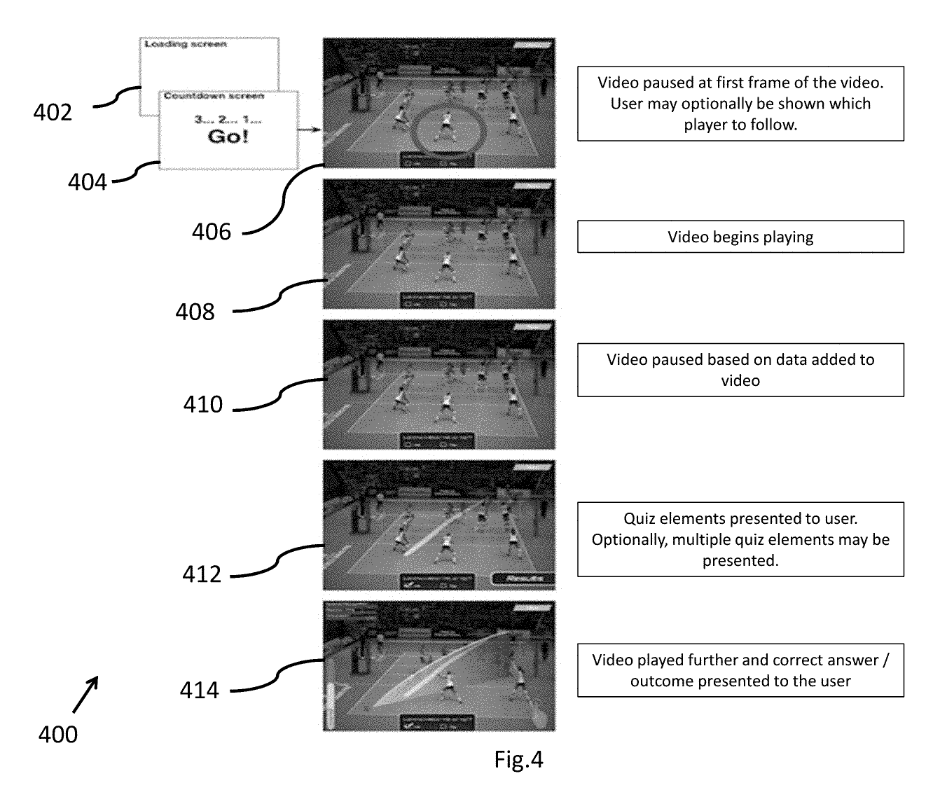

FIG. 4 is a collection 400 of illustrative screenshots of how a video game involving a volleyball video progresses and the manner in which user response is sought on the volleyball video in accordance with the method described herein. One the video game screen loads 402 there optionally may be a countdown screen 404 that indicates to a user that the game is about to begin. The video is paused right at the first frame 406 and a specific player in the video is highlighted to inform the user which player to follow. Thereafter the video begins playing once again 408. The video is paused at a preset time in accordance with the data added to the video 410. An interactive quiz element is presented to the user wherein the user is asked to determine the path of the ball 412. This quiz element is already attached with the video when the data is initially added to the video. Once the user responds to the quiz element, the video plays further 414 to show the correct outcome to the user. The user may be optionally asked multiple quiz elements at the point of occlusion.

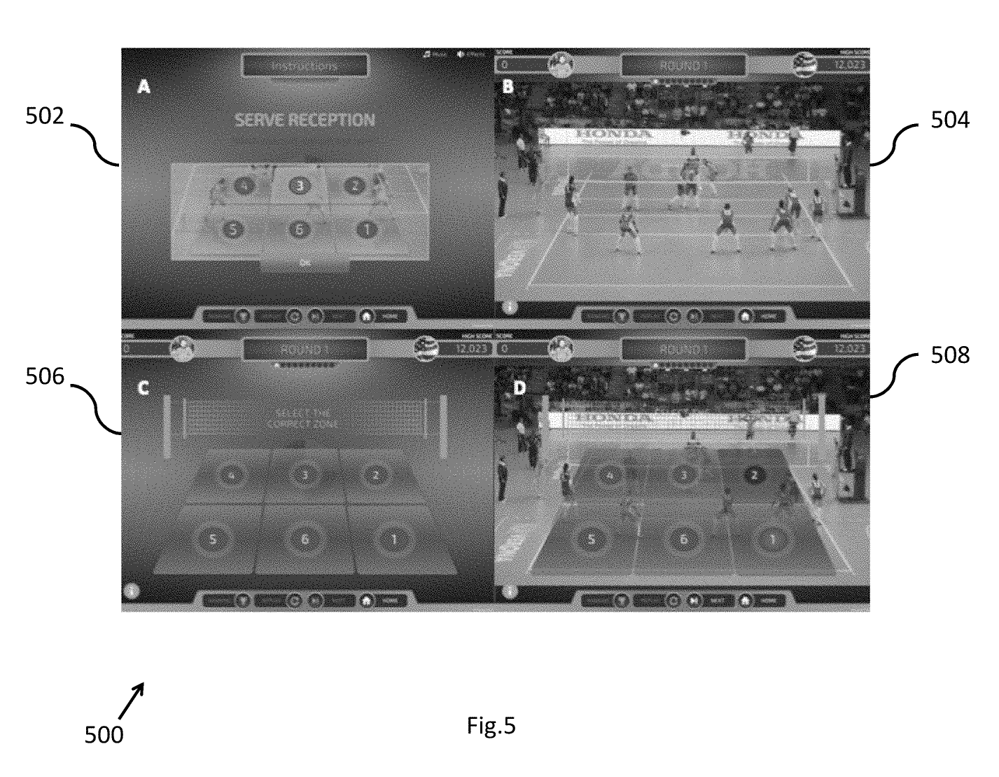

The video interruption may be carried out in various ways such as pausing the video and showing written question on top of the paused screen, occluding the video by showing a black/blank screen etc. FIG. 5 is an illustrative screen shot 500 of an alternate embodiment in accordance with the method provided herein where for the video occlusion the screen doesn't turn black. In a volleyball data added video, at the start of the video 502 the instructions are presented where the player is told to select where the ball from the serve will end up. Thereafter, the video is played 504 and it continues to play until the point of occlusion that is preset as per the data added to the video. At the point of occlusion the screen instead of turning black, shows the empty volleyball court without the players where the court is marked in various zones 506. In this illustration, the volleyball court is divided into six zones (1 to 6). The user is asked to select the zone where the user feels the ball from the serve will land. Once the user provides a response, the video continues to play 508 and the final point of the ball is shown. Optionally, the point marked by the user and the actual point of the ball may be highlighted in different colors for a better user experience.

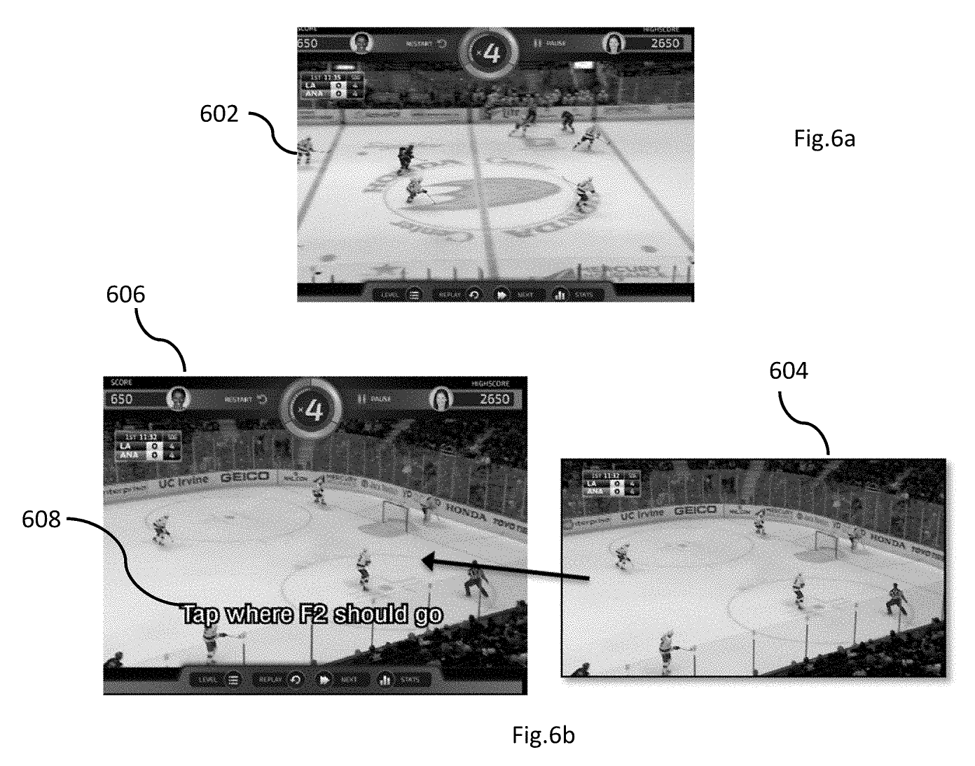

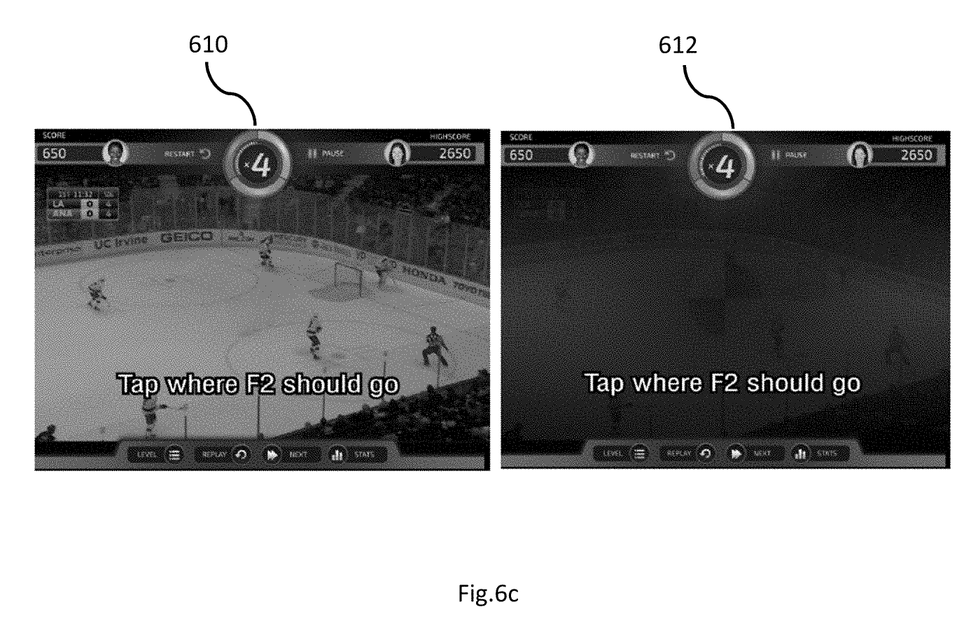

FIGS. 6a, 6b and 6c are illustrative screen shots of an alternate embodiment in accordance with the method provided herein. The occlusion in a data added video may be presented to the user with the help of a ‘Freeze Frame’. Once the video is paused at the point of occlusion, the video module is configured to replace the paused video with a still image (referred to as the “freeze frame”) and the quiz element is introduced on top of such freeze frame thereby enabling the user to respond in a better and more accurate manner. When the user begins a new game round (ice hockey in this illustration), a video is loaded and begins playing 602. When the video reaches its occlusion point (set in milliseconds or video frames in the data added to video) 604, the video is replaced with a freeze frame 606 and the question 608 is asked on top of the freeze frame. With time the freeze frame slowly starts fading 610 giving user an indication of the time remaining to answer the question. Ultimately, the freeze frame is faded out to alpha 0 over time 612 thereby making it look like a black screen to the user.

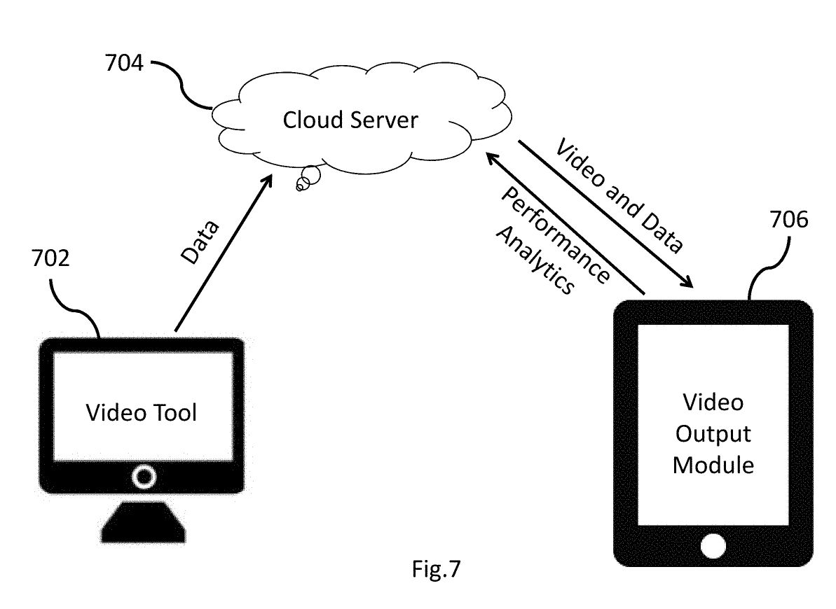

FIG. 7 is an illustrative embodiment of system architecture for improving the cognitive skills of a user, utilizing the method provided herein. Any person or organization may utilize a smart computing device 702 such as a desktop computer, laptop, tablet PC or a smartphone configured to run the video tool to export data to be added to a video. The video tool may comprise any known data embedding or data adding technique, now known or available in the future, used to add data to videos. The data may be exported in a pre-specified file format and may be stored on a cloud server 704 for use by multiple end users. A user may utilize a user device 706 configured to run the video output module to import the data and the video either bundled together as a single file or as separate files and play the video in accordance with such data. The video output module is configured to present the data added videos on the user device 706, extract the data commands added to the video and accordingly add interactive elements to the video such as interruptions/occlusion, asking quiz, highlighting specific portions of the video, seeking user response etc. The video output module may either pick data added videos pre-stored in user device's storage or alternatively pick such data added videos from a remote or cloud server 704. The video output module occludes the video at a preset default time as per the data added to the video. Once the video is occluded, the user is presented with appropriate quiz elements in accordance with the data added to the video. The user response to the quiz elements is sought.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for developing specific cognitive ability of a user, said method comprising:
adding data to a video resulting in a data added video;
presenting said data added video to a user on a user device;
interrupting said data added video in accordance with said data;
presenting said user with at least one question in relation to said data added video; and
soliciting said user's response to said question.

2. The method of claim 1 further comprising, analyzing said user's response by comparing said response with actual outcome.

3. The method of claim 1 further comprising, showing the actual outcome to said user after soliciting said user response.

4. The method of claim 1 further comprising, increasing or decreasing difficulty level of said interruption automatically based on user response.

5. The method of claim 1 wherein said adding is achieved by embedding data in said video.

6. The method of claim 1 wherein a video tool is used for uploading said data to said video.

7. The method of claim 1 wherein said interrupting of said data added video is achieved by occluding said data added video.

8. The method of claim 1, wherein said data added video is presented to said user in a video game environment.

9. The method of claim 1 wherein said user devices is configured to run a video output module wherein said video output module is used to select said data added video from a server and present said data added video to said user.

10. The method of claim 1, wherein said video is a real life video.

11. The method of claim 1, wherein said video is a simulated video.

12. The method of claim 1, wherein said video is an animated video.

13. The method of claim 1, wherein said data corresponds to default time at which said data added video is interrupted.

14. The method of claim 1, wherein said data corresponds to a quiz presented to said user wherein said quiz is related to an interruption point of such video.

15. The method of claim 1, wherein said data corresponds to at least one interactive question presented to said user wherein said interactive question is related to said interruption point of such video.

16. The method of claim 1 wherein said user device is a smart phone, tablet or a computing device.

17. The method of claim 1, wherein said user response is solicited using touch interface of a computing or mobile device.

18. The method of claim 1, wherein said user response is solicited using augmented reality system capturing said user's gestures.

19. The method of claim 7, wherein said occlusion of said data added video is achieved by replacing the occluded video by a freeze frame

20. The method of claim 19, wherein with time said freeze frame fades out of said user's view.
